(19) United States
(12) Patent Application Publication
(10) Pub. No.: US 2004/0200510 A1
(43) Pub. Date: Oct. 14, 2004

(54) Apparatus and method for splash-back proofing

(75) Inventors: Shih Ting Tseng, Chiayi (TW); Yu Cheng Chung, Neipu Township (TW); Ding Ruey Guo, Kuan Miao Shiang (TW)

Correspondence Address: BACON & THOMAS, PLLC, 625 SLATERS LANE, FOURTH FLOOR, ALEXANDRIA, VA, 22314

(73) Assignee: AU Optronics Corp., Hsinchu City (TW)

(21) Appl. No.: 10/724,744

(22) Filed: Dec. 2, 2003

(30) Foreign Application Priority Data
Apr. 11, 2003 (TW) 092108463

(51) Int. Cl. B08B 3/02

(52) U.S. Cl. 134/33; 134/34; 134/42; 134/148; 134/153; 134/182; 134/902

(57) ABSTRACT

This invention relates to an apparatus for splash-back proofing, being used for treating a panel or substrate in photolithographic process. The present invention prevents a liquid (such as developer or photoresist solution) dripping on the surface of the substrate or panel from splashing back to the substrate or panel after scattering to the periphery of the substrate or panel by spin-coating. The splashing-back liquid will bring about defects in the patterning or photolithographic process, and result in deterioration of products. The apparatus for splash-back proofing includes a rotating device, at least a liquid spray unit, a guard means surrounding part of the rotating device and a roughening unit. Also, a method for splash-back proofing is disclosed.

### BACKGROUND OF THE INVENTION

1. Field of the Invention

The present invention relates to an apparatus and a method for splash-back proofing, and more particularly to an apparatus and a method for preventing liquid developer or water from splashing-back in a developing process or a scrubbing process.

2. Description of Related Art

In the conventional fabrication process of thin-film-transistor liquid crystal displays (TFT-LCDs), a thin-film-transistor pattern is first formed on a clean glass substrate. This is very similar to the known fabrication process for semiconductors. In the beginning, a thin film such as a metal film or a dielectric film is deposited. A photoresist solution is supplied in a photolithography chamber. A photo mask is used for exposure. A liquid developer is sprayed in a development section to remove the photoresist after the photolithographic process, and then, a photoresist layer is patterned. The exposed thin film is etched away, and the remaining photoresist is removed after the etching process. Hence, a circuit pattern of the transistor as required is formed.

There are various manners applicable to the development. It is common in the art to have the liquid developer sprayed onto the surface of a substrate mounted on a rotating device. As shown in FIG. 2, a developing apparatus 100 is equipped with a rotating device 110 having an outer cup 120 at the outer periphery of the rotating device 110. A guard means 121 having a length of about 10 cm is integrally formed with the outer cup 120, being made of stainless steel to form a smooth surface. The guard means 121 is mounted at the upper periphery of the outer cup 120. With this arrangement, the liquid developer is prevented from splashing outwardly to the ambient area of the development apparatus when the rotating device 100 is in high speed rotation. However, some of the liquid developer splashes back to the substrate, as indicated by an arrow 131 in FIG. 2, because the liquid developer hits against the stainless steel guard means 121 at high speed. The splashed-back developer brings about an adverse effect on yield of production, and tends to be worse as far as a thinner substrate is concerned. If a thinner substrate is provided in high speed rotation, the peripheral portion of the substrate will be lifted up higher and more of the splashed-back developer will be presented, as indicated by an arrow 132 in FIG. 2. For example, the amount of the splashed-back liquid developer occurring in a glass substrate having a thickness of 0.63 mm is more than that occurring in a glass substrate having a thickness of 0.7 mm.

In addition, in a case where a scrubber is used, deionized water also splashes back to the substrate surface in the stage of high speed spin drying after a washing process. The substrate is therefore susceptible to having a mist or moisture deposited thereon. As a result, the properties of the film so formed are adversely affected, and also, the yield is lowered.

Therefore, it is desirable to provide an apparatus and a method for splash-back proofing an apparatus to mitigate and/or obviate the aforementioned problems without significantly increasing fabrication cost.

### SUMMARY OF THE INVENTION

It is a primary object of the present invention to provide an apparatus for splash-back proofing capable of effectively preventing a liquid from splashing back to the surface of a substrate after hitting against the walls of a reactor, so as to increase yield and reliability of production.

It is another object of the present invention to provide a method for splash-back proofing capable of effectively preventing a liquid from splashing back to the surface of a substrate after hitting against the walls of a reactor so as to increase yield and reliability of production.

To attain the above-mentioned objects, an apparatus for splash-back proofing according to the present invention is adopted for a substrate, and comprises a rotating device for holding and rotating the substrate, at least a liquid spray unit mounted on one side of the rotating device for spraying a liquid to the substrate, a guard means surrounding part of the rotating device for preventing the liquid from scattering to the outer portion of the rotating device, and a roughening unit overlaying part of the guard means for preventing the liquid hitting against the guard means from splashing-back.

A method for splash-back proofing is adopted for a substrate, and comprises the following steps: providing a processing apparatus comprising a rotating device for rotating the substrate, a liquid spray unit mounted on one side of the rotating device for spraying a liquid to the substrate, and a guard means surrounding part of the rotating device for preventing the liquid from scattering to the outer portion of the rotating device; and roughening the surface of the guard means.

The substrate being treated in the apparatus and method according to the present invention is not specifically defined, and can be any conventional one. Preferably, the substrate is a silicon wafer, a panel or a glass substrate. The liquid used in the apparatus and method according to the present invention is not specifically defined, and can be any conventional one. Preferably, the liquid is developer or water. The guard means used in the apparatus and method according to the present invention is not specifically defined, and can be any conventional one. Preferably, the guard means is made of stainless steel. The roughening unit used in the apparatus and method according to the present invention is not specifically defined, and can be any conventional one. Preferably, the roughening unit is a sponge, a stainless steel web or a roughened surface of a stainless steel web. The machine suitable for being used with the apparatus and method according to the present invention is not specifically defined, and can be any conventional one. Preferably, the machine is a developing apparatus or a scrubber.

Other objects, advantages, and novel features of the invention will become more apparent from the following detailed description when taken in conjunction with the accompanying drawing.

### BRIEF DESCRIPTION OF THE DRAWINGS

FIG. 1 is a schematic view of a preferred embodiment of a development chamber according to the present invention; and

FIG. 2 is a cross-sectional view of a prior development chamber.

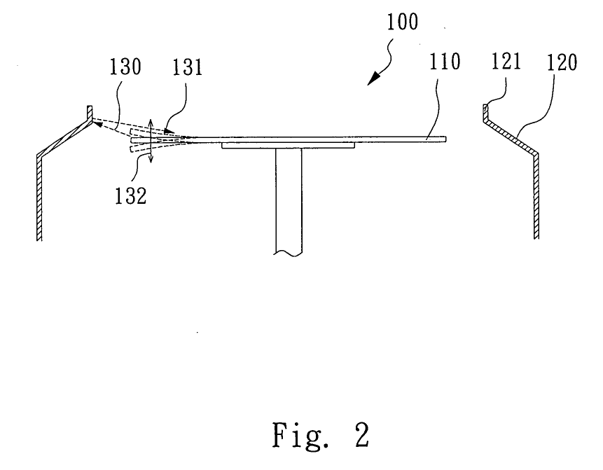

### DETAILED DESCRIPTION OF THE PREFERRED EMBODIMENT

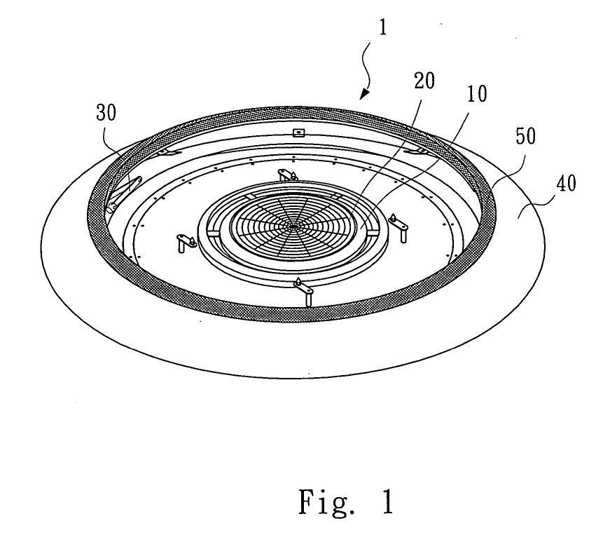

FIG. 1 illustrates a schematic diagram of a development chamber. Development chamber 1 comprises a rotating device 10 for rotating a substrate 20, a liquid spray nozzle 30 mounted on a side of the rotating device 10 for spraying a liquid developer to the substrate 20, a stainless steel guard means 40 surrounding the rotating device 10 for preventing the liquid developer from scattering to the outer portion of the development chamber wherein the guard means 40 has a smooth surface. It is desired to make an improvement over the structure of the currently used developing tank so as to reduce the amount of the splashed-back developer. In the present embodiment, a stainless steel web 50 having a thickness in the range of from 1 mm to 20 mm overlays the guard means 40 is used. By using the principle of filtration film, the characteristics of liquid molecules (i.e., easy-to-enter and hard-to-exit) and rebound of the liquid molecules in the form of micro-molecule to be carried away by an air-extracting device in the developing apparatus as a result of a secondary hit which reduces the volume and acting force of the splashing-back developer if any, the possibility of the developer splashing back to the substrate 20 after hitting against the guard means 40 is reduced. Table 1 shows a comparison of yield loss as a result of the splashing-back of the developer between before and after the stainless steel web 50 overlays the guard means 40.

TABLE 1

| Guard means arrangement of development chamber | Yield loss |
|---|---|
| With guard means only | 0.11% |
| Adding a stainless steel web to guard means | 0.01% |

It is certain that the roughness of the surface of the guard means 40 is increased by adding the stainless steel web 50 to reduce an elastic impact caused by the liquid molecules on the surface of the guard means 40. In addition to the stainless steel web 50 as used in the present embodiment, any other material capable of increasing the roughness of the surface of the guard means 40 can be adopted for achieving the same or similar purpose. For instance, a sponge may be used, or alternatively, the purpose is achieved by directly roughening the surface of the guard means 40. Hence, the elastic impact caused by the liquid molecules of the developer by hitting against the surface of the guard means is greatly reduced so as to prevent the developer from splashing back to the substrate surface. Moreover, the method for roughening the surface of the guard means 40 can be completed by mechanical knock, blast, surface spray, friction or chemical etch, etc. Furthermore, the present invention can also be applied to any processing apparatus having a liquid spray mechanism by spin-coating such as the scrubber process.

Although the present invention has been explained in relation to its preferred embodiment, it is to be understood that many other possible modifications and variations can be made without departing from the spirit and scope of the invention as hereinafter claimed.

What is claimed is:

1. An apparatus for splash-back proofing adopted for a substrate, comprising:
a rotating device for holding and rotating said substrate;
at least a liquid spray unit mounted on one side of said rotating device for spraying a liquid to said substrate;
a guard means surrounding part of said rotating device for preventing said liquid from scattering to an outer portion of said rotating device; and
a roughening unit overlaying part of said guard means for preventing said liquid hitting against said guard means from splashing-back.

2. The apparatus of claim 1, wherein said substrate is a silicon wafer, a panel or a glass substrate.

3. The apparatus of claim 1, wherein said liquid is developer or water.

4. The apparatus of claim 1, wherein said guard means is made of stainless steel.

5. The apparatus of claim 1, wherein said roughening unit is a sponge, a stainless steel web or a roughened surface of a stainless steel web.

6. The apparatus of claim 1, wherein said apparatus is well suited to a developing apparatus or a scrubber.

7. A method for splash-back proofing adopted for a substrate, comprising the following steps:
(A) providing a processing apparatus, comprising:
a rotating device for rotating said substrate,
a liquid spray unit mounted on one side of said rotating device for spraying a liquid to said substrate, and
a guard means surrounding part of said rotating device for preventing said liquid from scattering to the outer portion of said rotating device; and
(B) roughening the surface of said guard means.

8. The method of claim 7, wherein said processing apparatus is well suited to a developing apparatus or a scrubber.

9. The method of claim 7, wherein said substrate is a silicon wafer, a panel or a glass substrate.

10. The method of claim 7, wherein said liquid is developer or water.

11. The method of claim 7, wherein said guard means is made of stainless steel.

12. The method of claim 7, wherein said step (B) is achieved by rubbing the surface of said guard means with a stainless steel web.

13. The method of claim 7, wherein said step (B) further comprises a roughening unit mounted outside said guard means.

14. The method of claim 13, wherein said roughening unit is a sponge, or a stainless steel web.
